(19) United States
(12) Patent Application Publication
(10) Pub. No.: US 2026/0096540 A1
(43) Pub. Date: Apr. 9, 2026

(54) A METHOD FOR DISPENSING MATERIAL CONSUMED BY AN ANIMAL AND MONITORING THE ANIMAL'S CONSUMPTION OF THE MATERIAL, AND RELATED SYSTEMS AND DEVICES

(71) Applicant: Dan Munro, Snohomish, WA (US)

(72) Inventor: Dan Munro, Snohomish, WA (US)

(21) Appl. No.: 19/112,987

(22) PCT Filed: Sep. 22, 2023
(86) PCT No.: PCT/US2023/033539

§ 371 Date: Mar. 19, 2025

Related U.S. Application Data
(60) Provisional application No. 63/376,711, filed on Sep. 22, 2022.

(51) Int. Cl. A01K 29/00; A01K 5/02; A01K 7/02

(52) U.S. Cl. CPC A01K 29/005; A01K 5/0275; A01K 7/02

(57) ABSTRACT

A method for monitoring an animal's consumption of material includes sensing an amount of material that is held in a container and that is to be consumed by an animal, and comparing the sensed amount with an amount of material that was previously sensed in the container. Then, in response to the sensed amount of material being less than the previously sensed amount of material, the method also includes determining whether the animal consumed the removed material. In response to the animal consuming the removed material, the method then includes calculating the amount of material consumed by the animal, recording the amount of material consumed by the animal, and establishing the sensed amount of material as the amount of material previously-sensed for use in a future comparison of a subsequent execution of the method.

### CROSS-REFERENCE TO RELATED APPLICATIONS AND INCORPORATION BY REFERENCE

This application claims priority from U.S. PCT Patent Application PCT/US23/33539 filed 22 Sep. 2023 and titled “A METHOD FOR DISPENSING MATERIAL CONSUMED BY AN ANIMAL AND MONITORING THE ANIMAL'S CONSUMPTION OF THE MATERIAL, AND RELATED SYSTEMS AND DEVICES”, and from U.S. Provisional Patent Application 63/376,711 filed 22 Sep. 2022 and titled “Control Process/System for Cascada Automatic Waterer and Animal Consumption Monitoring System”. This application also incorporates by this reference the entirety of U.S. PCT Patent Application PCT/US23/33539, and the entirety of U.S. Provisional Patent Application 63/376,711.

### BACKGROUND

Proper care for an animal requires that the animal have access to fresh water. This is especially true when caring for horses, cows, and/or sheep. When such animals are corralled or fenced into a field, a common method for providing such access to fresh water is to place a trough in the corral, paddock, and/or fenced-in field, and have water continuously trickle into the trough.

Unfortunately, supplying a continuous trickle of water to the trough often leads to wasting water when the animals don't drink as much as anticipated, or when the valve that regulates the flow of water fails. To overcome this problem, one typically supplies water to the trough when the amount of water in the trough falls below a specific level. If one has to do this himself/herself, then one has to check on the water level at least once a day, and if needed, add more water to the trough. This is especially true when a bucket, typically 5-gallon capacity, hanging from a wall and holding water is used instead of a trough. Horses typically drink about 10 gallons of water a day, therefore one has to check and fill each bucket multiple times a day. This, however, consumes valuable time, especially on a ranch or when caring for many animals, that could otherwise be used for other projects. To free one from this time-consuming chore, many configure an automatic waterer for the trough, that senses when the amount of water in the trough falls below a specific level. When this occurs, the automatic waterer opens a valve on the water supply line to allow water to flow into the trough, similar to the functionality of a float valve in a toilet tank.

Unfortunately, though, such a system has two problems. First, such systems typically operate to keep the amount of water in the trough at a constant level. As soon as the amount of water falls below a specific desired amount, the system opens the supply valve, and as soon as the amount of water reaches the same specific desired amount, the system closes the supply valve. Thus, in operation, the supply valve frequently cycles through opening and closing in response to the amount of water frequently falling below the specific desired amount. This frequent cycling often causes premature damage to the valve.

Second, such systems do not allow a convenient & remote method for monitoring the water consumption of a specific animal. Thus, it's very difficult to gauge the health of a specific animal by monitoring the animal's water and/or food consumption, without manually monitoring the animal's consumption with one's own eyes. Because of this, such monitoring is not frequently done, or done only after an adverse health event, and because of this, many problems with animals that could be easily resolved if discovered quickly, aren't resolved and sometimes turn fatal.

Thus, there is a need for an apparatus that monitors an animal's consumption of material, such as water, food and/or medicine, and efficiently supplies the material automatically when needed.

### SUMMARY

In one aspect of the invention, a method for monitoring an animal's consumption of material includes sensing an amount of material that is held in a container and that is to be consumed by an animal, and comparing the sensed amount with an amount of material that was previously sensed in the container. Then, in response to the sensed amount of material being less than the previously sensed amount of material, the method also includes determining whether the animal consumed the removed material. In response to the animal consuming the removed material, the method then includes calculating the amount of material consumed by the animal, recording the amount of material consumed by the animal, and establishing the sensed amount of material as the amount of material previously-sensed for use in a future comparison of a subsequent execution of the method.

By knowing whether the animal consumed the material that was removed from the container, one can accurately determine the amount of material that the animal consumes over a period, such as the period that it takes for the animal to remove the material in a single event, and/or throughout the day, and/or throughout the week, and/or throughout the month. In this manner, one can monitor the health of the animal and can identify potential health issues early before such issues become serious problems. In addition, one can develop a history unique to the animal and then use the history to also identify potential health issues early before such issues become serious problems. This would allow one to identify an issue with a specific animal even though the specific animal's abnormal consumption falls within the general norm established by a large number of the same animal species.

In another aspect of the invention, a method for monitoring an animal's consumption of material includes: a) a transmitter transmitting a signal toward material located in a container, b) reflecting the signal from a surface of the material, c) a receiver receiving the echo of the transmitted signal, and analyzing the echo for noise. Then, in response to the echo having noise in an amount less than a threshold amount of noise: a) using the echo to determine the distance of the surface of the material from the receiver; and b) comparing the determined distance with the distance of the surface of the material from the receiver that was determined from a previous echo from the surface of the material located in the container. In response to the previously determined distance being shorter than the currently determined distance, the method then includes comparing the currently determined distance with a maximum distance, and, in response to the currently determined distance exceeding the maximum distance, adding material to the container. By analyzing the echo for noise, and using the echo to determine the distance of the surface of the material from the receiver when the amount of noise in the echo is below a threshold amount, one can get an accurate reading of the amount of material removed from the container.

In yet another aspect of the invention, a system for monitoring an animal's consumption of material includes: a transmitter, a receiver, a valve, and a controller. The transmitter is operable to transmit a signal toward material located in a container. The receiver is operable to receive the signal reflected from a surface of the material. The valve is operable to control the flow of the material into the container from a source of the material. The controller is coupled with the transmitter, the receiver and the valve, and is operable to analyze the signal received by the receiver for noise, and in response to the received signal having noise in an amount less than a threshold amount of noise then the controller is operable to: a) use the received signal to determine the distance of the surface of the material from the receiver; b) compare the determined distance with the distance of the surface of the material from the receiver that was determined from a signal previously reflected from the surface of the material located in the container. Then in response to the previously determined distance being shorter than the currently determined distance, the controller is operable to compare the currently determined distance with a maximum distance, and: a) open the valve to add material to the container if the currently determined distance is greater than a maximum distance, and b) close the valve to not add material to the container if the currently determined distance is less than a minimum distance wherein the minimum distance is different than the maximum distance.

### BRIEF DESCRIPTION OF THE DRAWINGS

FIG. 1 shows a schematic view of a system for monitoring an animal's consumption of material, according to an embodiment of the invention.

FIG. 2 shows a view of a container and a device of the system positioned above the container that monitors the removal and addition of material from and into the container, according to an embodiment of the invention.

FIG. 3 shows a flowchart of a method for monitoring an animal's consumption of material, according to an embodiment of the invention.

FIG. 4 shows a flowchart of another method for monitoring an animal's consumption of material, according to another embodiment of the invention.

### DETAILED DESCRIPTION

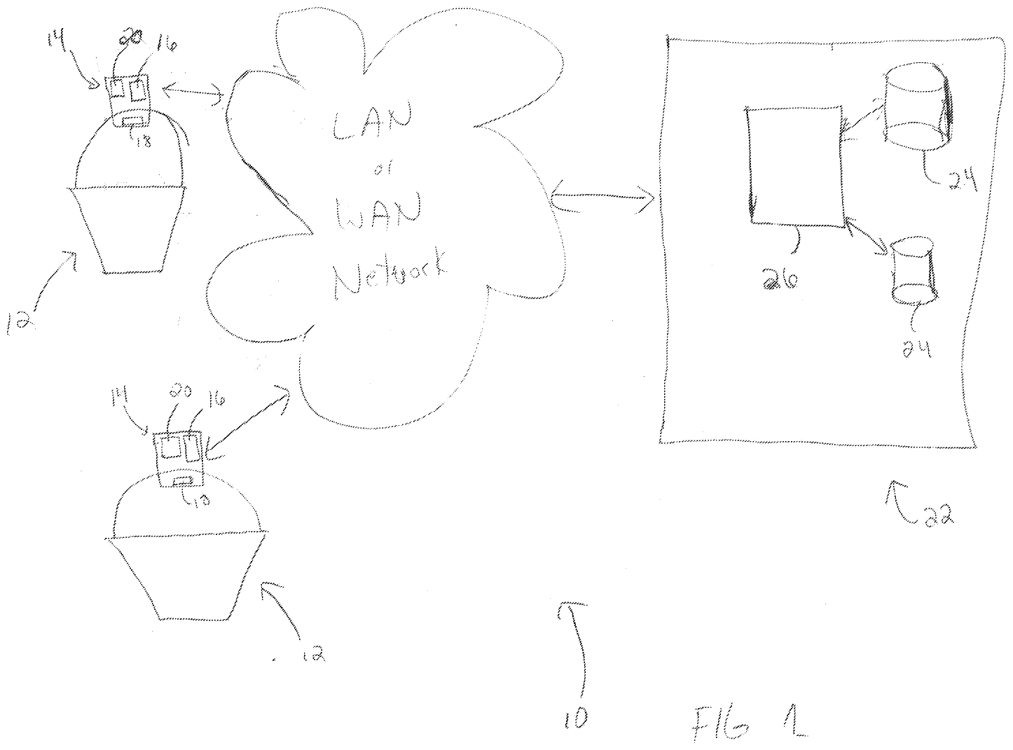

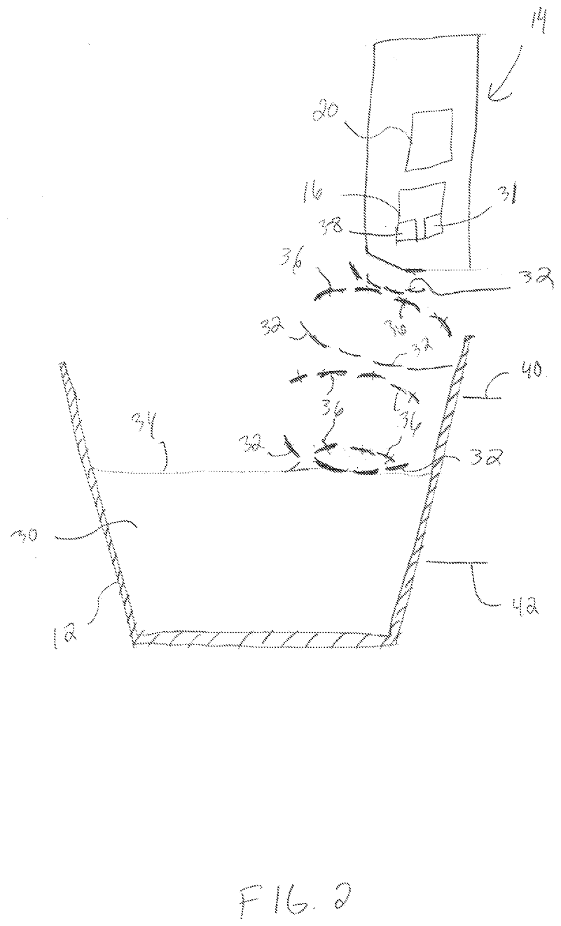

FIG. 1 shows a schematic view of a system 10 for monitoring an animal's consumption of material, according to an embodiment of the invention. The system 10 includes a container 12 (two shown, arbitrarily) that one uses to hold material for an animal, such as a horse, cow, sheep and/or rabbit, to consume. Here the container 12 is a bucket that holds five gallons; and the material is water and/or medicine. In other embodiments the container 12 may be a trough that holds fifty gallons; and the material may be food. The system 10 includes a device 14 that monitors the amount of material held in the container 12 and dispenses material into the container 12 when the amount in the container is low. To do this, the device 14 includes a sensor 16 (discussed in greater detail in conjunction with FIG. 2) that senses the amount of material in the container 12, a valve 18 to control the flow of material into the container 12 from a source (not shown), and a controller 20 (also discussed in greater detail in conjunction with FIG. 2) to direct the valve 18 to open or close in response to the sensor 14 sensing a specific amount of material in the bucket 12. The system 10 also includes a computer or server 22 that stores data from the device 14 and corresponds the data with a specific device 14, a specific animal associated with the device 14, and/or both to allow one to monitor the consumption rates of the animal and the functionality of the device 14. The system 10 also includes a network, such as an LAN and/or a WAN, through which the device 14 and server 22 communicate.

More specifically, when the sensor 14 senses that the amount of material in the container 12 has decreased, the controller 20 determines whether the animal associated with the container 12 has consumed the material. In response to the animal consuming the removed material, the controller 20 then calculates the amount of material consumed by the animal. If the amount of material remaining in the container 12 is less than or equal to a minimum amount, the controller 20 then directs the valve 18 to open to dispense material into the container 12. If the amount of material remaining in the container 12 is more than or equal to a maximum amount, the controller 20 then directs the valve 18 to close to stop dispensing material into the container 12. The maximum amount of material that triggers the controller 20 to direct the valve 18 to close is greater than the minimum amount of material that triggers the controller 20 to direct the valve 18 to open. For example, the minimum amount of material in the container 12 that triggers the controller 20 to open the valve 18 may be two gallons, and the maximum amount of material in the container 12 that triggers the controller 20 to close the valve 18 may be four gallons.

By knowing whether the animal consumed the material that was removed from the container 12 along with the specific time of day that the amount was consumed, one can accurately determine the amount of material that the animal consumes over a period, such as during a single consumption event, and/or throughout a day, and/or throughout a week, and/or throughout a month. In this manner, one can monitor the health of the animal and can identify potential health issues early before such issues become serious problems. In addition, one can develop a history unique to the animal and then use the history to also identify potential health issues early before such issues become serious problems. This would allow one to identify an issue with a specific animal even though the specific animal's abnormal consumption falls within the general norm established by a large number of the same animal species. And, with the ability to trigger the opening of the valve 18 when the amount of material in the container 12 falls below a minimum amount that is substantially less than the maximum amount of material that triggers the closing of the valve 18, the frequency of the on-off cycling of the valve 18 is reduced, which in turn reduces wear and tear on the valve 18.

Associating data gathered by a specific device 14 with a specific animal may be accomplished in any desired manner. For example, in this and other embodiments, the specific device 12 may be manually associated with a specific animal. This works well when a paddock or pen in which a device 14 is located confines a single animal. The paddock may contain one, two, three or more devices 14 and corresponding containers 12 of which some of the containers 12 hold water and some of the other containers 12 hold food. Each device 14 is uniquely identified, and the server 22 records and organizes the data received from the devices 14 according to the unique identifier of each device 14. Because a single animal is confined in the paddock or pen, any amount of water and/or food that is determined to be consumed by an animal, is assumed to be consumed by the animal confined in the pen. If, however, more than one specific animal is to be monitored by the system 10, then each of the devices 14 may include a second sensor (not shown) that senses a unique characteristic of an animal consuming material from the container 12 that can be used to identify that animal among the other animals confined in the paddock. With the identity of the animal known, the server 22 can record the data received from a specific device 14 with the specific animal responsible for the specific consumption. The second sensor may be any desired sensor capable of performing this function, such as a camera, and the server 16 may run the visual data from the camera through recognition software to determine the specific animal's unique identity.

Still referring to FIG. 1, the data gathered by the device 14 may be any data desired. For example, in this and other embodiments the data gathered by the device 14 includes the amount of material in the container 12, the time that the amount of material was sensed (timestamp), the device's unique identifier, and the identity of the animal responsible for removing material from the container 12 when material is removed by an animal. The controller 20 can calculate the amount of material removed from the container 12 by comparing the amount of material in the container 12 associated with the current timestamp with the amount of material in the container 12 associated with a previous timestamp. The previous timestamp may be the immediately preceding timestamp, or an earlier one if the data associated with the immediately preceding timestamp was corrupt or not accurate (discussed in greater detail in conjunction with FIG. 2).

Still referring to FIG. 1, the server 22 may be any desired system capable of storing and processing data. For example, in this and other embodiments, the server 22 may include a computer such as a conventional desktop or laptop computer having Windows, or OSX operating system, a database 24, and a processer 26 for executing programs. The server 22 receives data from the device 14, records the data, and calculates additional information from the data received from the device 14. For example, the server 22 may calculate an average consumption based on any desired period, such as mornings, afternoons, days, weeks, and/or months. The server 22 may then compare the recently obtained consumption data with historical average consumption data, which may span months or years, or specific days or specific weeks. The server 22 may also be configured to then identify changes in the consumption data and alert one to a possible change in the health or condition of the corresponding animal reflected by the animal's change in consumption. Such changes in the consumption data may result from a change in the weather, the season, the animal's activity level, age, health, current medications being taken, and/or pregnancy. Specifically, the server 22 runs software that adapts or accounts for the season, age, and other factors unique to a specific animal, and then compares the currently obtained consumption data with data representing the average consumption for the specific animal over an immediately preceding period (here two weeks). This comparison allows one to identify recent changes in the animal's consumption that, in turn, allows one to quickly identify any issues that the animal may be having. The server 22 may also be configured to allow one to access the recorded and calculated data from any location, as well as push significant alerts to one to make sure that a possible detrimental change to an animal's health is quickly addressed.

FIG. 2 shows a view of a container 12 and a device 14 of the system 10 positioned above the container 12 that monitors the removal and addition of material 30 from and into the container 12, according to an embodiment of the invention. In this and other embodiments, the device 14 is similar to the device discussed and claimed in international PCT patent application PCT/US22/71136, filed 14 Mar. 2022, and U.S. patent application Ser. No. 18/550,269, filed 12 Sep. 2023, both titled A Device For Dispensing Material Consumed By An Animal And Monitoring The Animal's Consumption Of The Material, And Related Systems And Methods, which are incorporated herein by this reference. Although not shown in FIG. 2, but shown and discussed in these two previous patent applications, the device 14 may include a coupler to hold the container 12 relative to the device 14. In other embodiments, the device 14 may be located relative to the container 12 as desired. When in these configurations, the device 14 needs to be calibrated to the distance that the device's sensor 16 lies away from the material held in the container 12, so that the controller 20 can accurately calculate the amount of material 30 in the container 12 as further discussed below.

The device 14 monitors the removal and addition of material 30 from and into the container 12 by sensing the amount of material 30 (here water) in the container 12 at any moment in time. The device's sensor 16 may be configured as desired to perform this function. For example, in this and other embodiments, the sensor 16 senses the level of the water 30 in the container 12 to determine the amount of water 30 held in the container 12. More specifically, the sensor 16 includes a transmitter 31 that generates a signal 32 (here a sound wave) and directs the signal 32 toward the water 30 in the container 12. The sensor 16 then measures the amount of time that it takes for the signal 32 to travel to the surface 34 of the water 30, reflect off the surface 34 as an echo 36, and then reach a receiver 38 of the sensor 16. With the speed of the signal 32 (here sound) through air known, and the time it takes for the signal 32 to travel to and from the surface 34 of the water 30, the sensor 16 and/or controller 20 of the device 14 can calculate the distance of the water's surface 34. With this distance information the sensor 16 and/or controller 20 may then determine the amount of water 30 held in the container 12 at that moment in time. In other embodiments, the sensor 16 may use a laser, a stereo camera, infrared light, microwaves, or any other type of physical phenomena that allows one to determine the distance of an object from the sensor 16. In still other embodiments, the sensor 16 may sense the weight of the water 30 in the container 12, to determine the amount of water 30 in the container 12. In still other embodiments, the sensor 16 may include a camera that captures a visual image of the water 30 in the container 12 to allow a person or other circuitry to compare the level with a mark or flag in the container that identifies an established, known volume. Using a visual image of the material 30 in the container 12 may be desirable when the material 30 to be consumed by the animal is medicine or food that is not a liquid.

The sensor 16 may be configured to transmit a sound wave 32 having any desired frequency, and may be configured to repeatedly generate at any desired frequency the sound waves 32. For example, in this and other embodiments the transmitter 31 may generate sound waves 32 having a frequency between 40 kHz and 500 kHz, and may generate between two and ten of these soundwaves 36 every second. More specifically, the soundwaves 32 have a frequency of 60 kHz-500 kHz, which is above the frequency that most animals can hear, and the transmitter 31 generates five of these sound waves 32 every second. Moreover, in this and other embodiments, the transmitter continuously generates five sounds waves every second so that the device 14 may always know the amount of water 30 in the container 12.

To minimize noise in the echo 36 that the receiver 38 receives, the sensor 16 or controller 20 tests the echo 36 for noise. Noise is unwanted modifications to the echo 36 that may be caused by other sounds near the sensor 16 and container 12 that mask or otherwise interfere with the soundwave 32 and/or echo 36. Noise can also be generated by objects interfering with the transmission of the sound wave 32 and/or echo 36, such as dust, an insect flying in the path of the transmission, a disturbance of the surface 34 that scatters the echo 36, and/or a nose of an animal drinking water from the container 12. Noise can also be generated by a magnetic field interfering with the electronic signal that the receiver 38 and/or transmitter 31 generates after receiving the echo 36, and/or before the transmitter 31 generates the soundwave 32. Noise in the echo 36 can make it difficult for the controller 20 to see the echo 36 that the controller 20 uses to determine the distance to the surface 34 of the water 30, which can cause the controller 20 to miscalculate the distance. So, to mitigate errors in the determination of the amount of water 30 in the container 12, the controller 20 oversamples or uses the echo from multiple sequential transmissions (samples), and monitors the variation between the echoes 36 in the samples. In this and other embodiments, the controller 20 uses the echo 36 from 100 samples, but the number of echoes or samples used may be more or less than 100. If the variation is small between samples, then the controller 20 averages the distances associated with each of the echoes to determine the distance of the surface 34 from the receiver 38, and then uses that distance to calculate the amount of water 30 in the container 12. If the variation is great between echoes or samples, then the controller 20 ignores the samples and collects a new set of echoes or samples over time until the variation in the echoes or samples is small to warrant averaging the distances associated with the echoes or samples.

Other embodiments are possible. For example, the controller 20 may determine whether an echo 36 has too much noise to be used to calculate the amount of water 30 in the container 12 by comparing the echo 36 with the soundwave 32 transmitted by the transmitter 31. If the signal-to-noise ratio is greater than a threshold ratio, then the controller 20 may ignore the echo 36, and test the subsequent echo 36. If the signal-to-noise ratio is less than a threshold ratio, then the controller 20 may use the echo 36 to calculate the amount of water 30 in the container 12. Comparing the echo 36 with the transmitted soundwave 32 allows the device 14 to handle noise that is not transient or temporary, and that may have to be physically removed.

The controller 20 may determine the amount of water 30 in the container 12 from echoes 36 in any desired manner. For example, in this and other embodiments, the controller 20 uses the following second order polynomial equation to approximate the volume of water 30 in the container 12.

$$Volume = 0.01975 ( {d}^{2} ) - 35.35 ( d ) + 11791.5$$

Volume is in tenths of an ounce (oz/10), and
d is the distance reading from the echo 36 in millimeters.

This equation works well for the container 12 that is a conventional five-gallon bucket 12. If differently configured containers 12 are used to hold material 30, then the equation should be modified to accurately reflect the change in volume as the distance of the water's surface 34 changes.

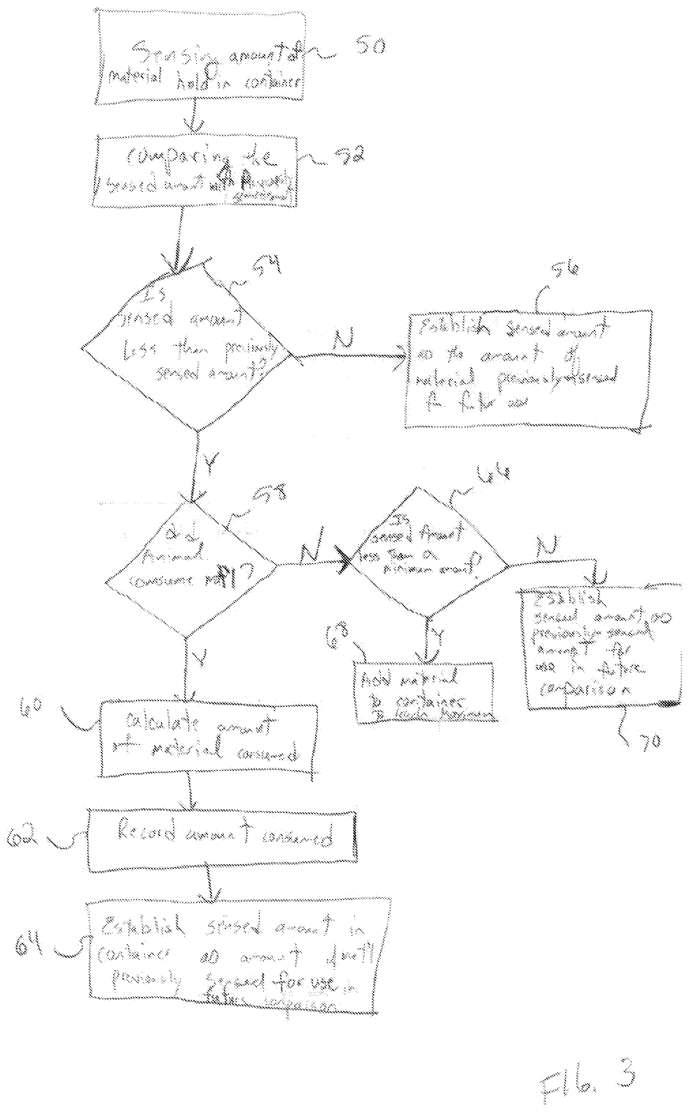

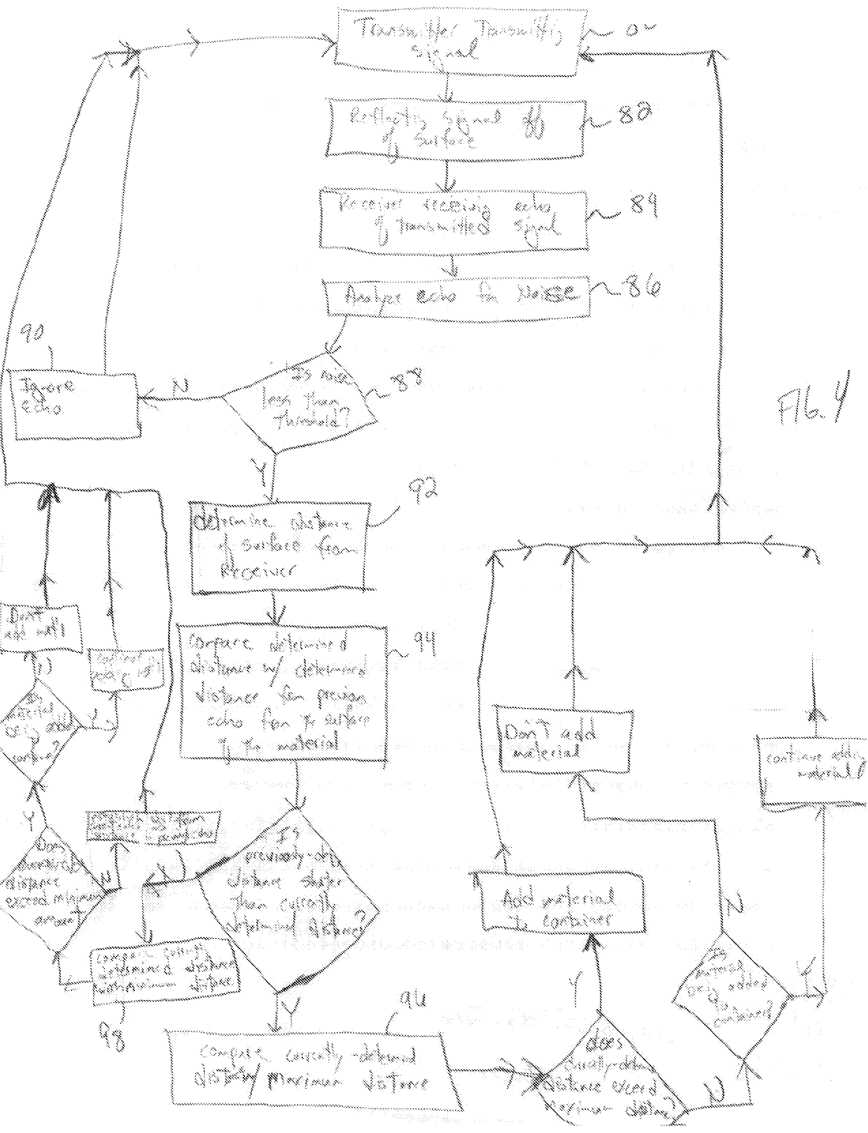

After the controller 20 calculates the amount of water 30 in the container 12, the controller 20 compares the amount with the amount of water 30 that it calculated in a preceding determination. The preceding determination may have been based on the multiple echoes 36 that formed a sample group that occurred immediately before the multiple echoes 36 that formed the sample associated with the current calculation. Or, the preceding determination may have been based on multiple echoes 36 that formed a sample group that occurred sometime before the multiple echoes 36 that formed the sample associated with the current calculation, if the amount of noise present in the immediately preceding determination exceeded a threshold amount. If the current amount of water 30 exceeds the previous amount of water 30, then water 30 has been added to the container 12. This can occur if the valve 18 (FIG. 1) has been open to refill the container 12, or water has been added in some other manner, such as rain. As discussed in greater detail in conjunction with FIGS. 3 and 4, the controller 20 then determines whether the current amount of water 30 exceeds a maximum amount (indicated in FIG. 2 by the level 40), and whether the valve 18 has been open. If the amount of water 30 has increased in some manner other than an open valve 18, then the controller 20 ignores the previously determined amount of water, uses the current calculation for a future comparison, and does not associate the difference in the amounts of water with a specific animal.

If, however, the current amount of water 30 is less than the previous amount of water 30, then water 30 has been removed from the container 12. This can occur if an animal consumes water 30 from the container 12, water 30 has evaporated from the container 12, or water 30 has been removed in some other manner. As discussed in greater detail in conjunction with FIGS. 3 and 4, the controller 20 then determines whether the water was consumed by an animal, and whether the current amount of water 30 is below a minimum amount (indicated in FIG. 2 by the level 42). If the amount of water 30 has been removed in some other manner, then the controller 20 determines whether evaporation caused the decrease in water 30 by comparing the rate at which the water 30 had been removed over successive echoes 36. The rate may be any desired rate that correlates with loss via evaporation. For example, in this and other embodiments if the rate of loss is 3 ounces or less per minute, then the controller 20 assumes the loss is from evaporation, and ignores the previously determined amount of water 30, uses the current calculation for a future comparison, and does not associate the difference in the amounts of water 30 with a specific animal. Water removal in some manner other than an animal or evaporation is assumed if the controller 20 determines that the water 30 was not removed by an animal or via evaporation.

As previously discussed in conjunction with FIG. 1, The maximum amount of water 30, as well as the minimum amount, may be any desired amount. For example, in this and other embodiments the maximum amount is four gallons, and the minimum amount 2 gallons. By establishing a maximum amount that is significantly different than the minimum amount, the device 14 is prevented from frequently cycling the valve 18 between on and off, which in turn reduces wear and tear on the valve 18.

Still referring to FIG. 2, when the device 14 senses an animal approaching the container 12, and/or drinking from the container 12, the controller 20 pauses the transmission and reception functions of the sensor 16. This reduces the probability of frightening the animal away from drinking from the container 12. This also allows the controller 20 to determine as a single consumption event the amount of water 30 that the animal consumes from the container 12. If the controller 20 didn't pause the transmission and reception functions, the controller 20 could perceive minimal noise in the echoes 36 if the animal's disturbance of the echoes 36 remained consistent over a large number of samples. This in turn would cause the controller 20 to miscalculate the amount of water 30 removed from the container 12.

If the device 14 is configured to sense an animal drinking from the container 12, the device 14 may be configured to do this by monitoring the variation between the echoes 36 in the samples, as previously discussed. The device 14 may also be configured to sense an animal drinking from the container 12 by calculating a distance based on an echo or echoes 36 that is shorter than the distance associated with the maximum amount of water for the container 12. In each of the configurations, once the controller 20 determines that an animal is drinking water from the container 12, the controller 20 pauses the refiling function of the valve 18, if the valve 18 has been in the open position. Then when the controller 20 determines that the animal has withdrawn from the container 12 by sensing little variation between a sample of echoes 36, and/or calculating a distance that lies between the distances associated with the maximum and minimum amounts of water, the controller 20 continues to monitor the consumption of the water from the container 12 and uses the amount of water from the most recent calculation before the animal entered the container 12 as a comparison.

Still referring to FIG. 2, the device 14 may include a system for protecting the valve 18 and nozzles (not shown) that dispense material 30 into the container 12 from freezing. For example, in this and other embodiments the device 14 may include a thermocouple (not shown) or some other sensor for sensing the temperature of the ambient environment, and an electric heater (also not shown) to heat to the valve 18 and nozzles. The controller 20 may monitor the temperature of the environment via the thermocouple, and when the temperature falls below a minimum (here 34 degrees F.), the controller 20 energizes the heater.

FIG. 3 shows a flowchart of a method for monitoring an animal's consumption of material, according to an embodiment of the invention. In this and other embodiments the method or process begins at step 50 with the sensor 14 (FIGS. 1 and 2) sensing an amount of material 30 (FIG. 2) that is held in a container 12 (FIGS. 1 and 2). Then, at steps 52 and 54, the controller 20 compares the sensed amount of material 30 with an amount of material 30 that was previously sensed in the container 12. If the sensed amount of material 30 is more than the previously sensed amount of material 30, then, at step 56, the controller 20 saves the sensed amount and identifies it as the previously sensed amount in the container 12 for a subsequent iteration of the method. If, however, the sensed amount is less than the previously sensed amount of material 30, then, at step 58, the controller 20 determines whether an animal consumed the removed material. This may be done by a camera or some other sensor, such as a second sensor as discussed in conjunction with FIG. 1, that can sense specific identifying information of the animal, or some other sensor that simply senses the presence of the animal, such as an infrared sensor. If the controller 20 determines that an animal has consumed the removed material 30 from the container 12, then, at step 60, the controller 20 calculates the amount of material 30 removed from the container 12, as previously discussed in conjunction with FIG. 2. Next, at step 62, the controller 20 records the amount consumed along with the time that the consumption occurred and, if applicable, the identity of the specific animal that consumed the material, and then transmits this data to the server 22 (FIG. 1) for further processing. Next, at step 64, the controller 20 saves the sensed amount and identifies it as the previously sensed amount in the container 12 for a subsequent iteration of the method.

If, however, the controller 20 determines that an animal has not consumed the removed material 30 from the container 12, then, at step 66 the controller 20 compares the sensed amount of material 30 with a minimum amount, as discussed in conjunction with FIG. 2. If the sensed amount is less than the minimum amount, then, at step 68, the controller 20 instructs the valve 18 to open to add material 30 to the container 12. The controller 20 also saves the sensed amount and identifies it as the previously sensed amount in the container 12 for a subsequent iteration of the method. If the sequent iteration of the method results in the sensed amount remaining below the maximum amount, then the controller 18 keeps the valve 18 open. If, however, the sensed amount reaches or exceeds the maximum amount, then the controller 20 closes the valve 18 to stop the addition of material 30 into the container 12.

If the sensed amount is more than the minimum amount, then, at step 70, the controller 20 keeps the valve 18 in the state (open or closed) that it is currently in, and saves and identifies the sensed amount as the previously sensed amount in the container 12 for a subsequent iteration of the method. This allows the device 14 to fill the container 12 to the maximum amount that then triggers the controller 20 to close the valve 18 and stop adding material 30 to the container 12, when the minimum amount in the container 12 is reached. But this prevents the device 14 from excessively cycling on and off when the amount of material sensed in the container 12 is less than the maximum amount and greater than the minimum amount.

FIG. 4 shows a flowchart of another method for monitoring an animal's consumption of material, according to another embodiment of the invention. In this and other embodiments the method or process begins at step 80 with the transmitter 31 (FIG. 2) transmitting a soundwave 32 (FIG. 2), followed by the soundwave 32 reflecting off the surface 34 (FIG. 2) as an echo 36 (FIG. 2), at step 82. Then, at step 84, the receiver 38 (FIG. 2) receives the echo 36. Next, at step 86, the controller 20 analyzes the echoes 36 as previously discussed in conjunction with FIG. 2, and at step 88, determines if the echoes 36 include too much noise, also as previously discussed in conjunction with FIG. 2. If the echoes 36 include too much noise, then at step 90, the controller ignores the echoes 36. If, however, the echoes 36 do not include too much noise, then, at step 92, the controller 20 calculates the distance of the surface 34 from the receiver 38. At step 94, the controller 20 then compares the currently calculated distance with the distance calculated from a previous group of echoes 36. If the distance calculated from the current echoes 36 is shorter than the distance calculated from a previous group of echoes 36, then, at step 96, the controller 20 compares the distance calculated from the current echoes 36 with the distance associated with the preestablished maximum amount of material in container 12—a minimum distance. Then, as previously discussed in conjunction with FIG. 3, the controller 20 either opens the valve 18, closes the valve 18, or keeps the valve 18 in the state (open or closed) that it was in when the transmitter 31 transmitted the soundwave 32.

If, however, the distance calculated from the current echoes 36 is longer than the distance calculated from a previous group of echoes 36, then, at step 98, the controller 20 compares the distance calculated from the current echoes 36 with the distance associated with the preestablished minimum amount of material in container 12—a maximum distance. Then, as previously discussed in conjunction with FIG. 3, the controller 20 either opens the valve 18, closes the valve 18, or keeps the valve 18 in the state (open or closed) that it was in when the transmitter 31 transmitted the soundwave 32.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. A method for monitoring an animal's consumption of material, the method comprising:
sensing an amount of material that is held in a container and that is to be consumed by an animal;
comparing the sensed amount with an amount of material that was previously sensed in the container;
in response to the sensed amount of material being less than the previously sensed amount of material, determining whether the animal consumed the removed material; and
in response to the animal consuming the removed material:
calculating the amount of material consumed by the animal,
recording the amount of material consumed by the animal, and
establishing the sensed amount of material as the amount of material previously-sensed for use in a future comparison.

2. The method of claim 1 wherein sensing the amount of material held in the container includes continuously sensing the amount of material held in the container.

3. The method of claim 1 wherein determining whether the animal consumed the removed material incudes:
determining the amount of material removed during a period,
comparing this amount with a threshold amount, and
in response to the amount of material removed during the period being less than the threshold amount, concluding that the material was not removed by the animal.

4. The method of claim 3 wherein the period is 60 seconds.

5. The method of claim 3 wherein the threshold amount is three ounces.

6. The method of claim 1 wherein calculating the amount of material consumed by the animal includes approximating a volume of the material consumed from a change in the location of the surface of the material in the container.

9. The method of claim 1 wherein recording the amount of material consumed by the animal includes the time of day of the consumption.

10. The method of claim 1 further comprising, in response to the animal consuming the removed material:
determining whether the sensed amount of material held in the container is below a minimum amount,
in response to the sensed amount being below the minimum amount, providing material to the container to increase the amount held in the container to a maximum amount, and
establishing the maximum amount of material in the container as the amount of material previously sensed for use in a future comparison.

11. The method of claim 1 further comprising, in response to the animal not consuming the material, establishing the sensed amount of material as the amount of material previously-sensed for use in a future comparison.

12. The method of claim 1 further comprising, in response to the animal not consuming the material:
determining whether the sensed amount of material held in the container is below a minimum amount,
in response to the sensed amount being below the minimum amount, providing material to the container to increase the amount held in the container to a maximum amount, and
establishing the maximum amount of material in the container as the amount of material previously sensed for use in a future comparison.

13. The method of claim 1 further comprising, in response to the sensed amount of material being more than the previously-sensed amount of material, establishing the sensed amount of material as the amount of material previously-sensed for use in a future comparison.

14. The method of claim 1 further comprising:
sensing when an animal is approaching the container, and
when an animal is approaching the container, not sensing an amount of material that is held in the container and that is to be consumed by an animal.

15. The method of claim 1 further comprising:
Sensing when an animal is in the container, and
When an animal is in the container and material is being provided to the container, stop providing material to the container.

16. The method of claim 1 further comprising comparing the amount of material consumed by an animal with the animal's historical consumption.

17. The method of claim 1 further comprising comparing the amount of material consumed by an animal with the animal's historical consumption, and generating an alarm when the amount of material consumed is substantially different than the animal's historical consumption.

18. A method for monitoring an animal's consumption of material, the method comprising:
a transmitter transmitting a signal toward material located in a container;
reflecting the signal from a surface of the material;
a receiver receiving the echo of the transmitted signal;
analyzing the echo for noise;
in response to the echo having noise in an amount less than a threshold amount of noise:
using the echo to determine the distance of the surface of the material from the receiver;
comparing the determined distance with the distance of the surface of the material from the receiver that was determined from a previous echo from the surface of the material located in the container;
in response to the previously determined distance being shorter than the currently determined distance:
comparing the currently determined distance with a maximum distance, and, in response to the currently determined distance exceeding the maximum distance, adding material to the container.

19. The method of claim 18 wherein the signal is a sound wave.

20. The method of claim 18 wherein the material located in the container is water.

21. The method of claim 18 wherein analyzing the echo for noise includes comparing the echo with a previous echo.

22. The method of claim 21 wherein the threshold amount of noise occurs when the difference between the two echoes is small.

23. The method of claim 18 wherein the distance to the surface of the material is determined by the duration between the transmission of the signal and the reception of the echo.

24. The method of claim 18 wherein the previous echo from the surface of the material resulted from a signal from the transmitter generated immediately prior to the currently transmitted signal.

25. The method of claim 18 further comprising calculating the volume of the material in the container from the distance of the surface of the material from the receiver.

26. The method of claim 18 further comprising, in response to the echo including noise in an amount greater than the threshold amount of noise, not using the echo to determine the distance of the surface of the material from the receiver.

27. The method of claim 18 further comprising, in response to the previously determined distance exceeding the currently determined distance, comparing the currently determined distance with a minimum distance and if the currently determined distance exceeds the minimum distance, then:
continue adding material, if material is being added,
not adding material, if material is not being added, and
saving the currently determined distance for use as a distance from a previous echo from the surface of the material located in the container, in a future comparison.

28. The method of claim 18 further comprising determining the location of an animal and in response to the location being near the container:
stop adding material to the container, if material is being added, and determining the identity of the animal.

29. The method of claim 28 wherein determining the location of an animal includes determining an amount of noise in the echo that exceeds the threshold amount of noise.

30. The method of claim 28 wherein determining the location of an animal includes:
comparing the currently determined distance with a minimum distance, and
in response to the currently determined distance being less than the minimum distance, concluding that an animal is in the container.

31. The method of claim 18 further comprising, in response to the previously determined distance being shorter than the currently determined distance, determining whether an animal consumed the removed material.

32. A system for monitoring an animal's consumption of material, the system comprising:
a transmitter operable to transmit a signal toward material located in a container;
a receiver operable to receive the signal reflected from a surface of the material;
a valve operable to control the flow of the material into the container from a source of the material; and
a controller coupled with the sensor and with the valve, and operable to:
analyze the signal received by the receiver for noise, and in response to the received signal having noise in an amount less than a threshold amount of noise then the controller is operable to:
use the received signal to determine the distance of the surface of the material from the receiver;
compare the determined distance with the distance of the surface of the material from the receiver that was determined from a signal previously reflected from the surface of the material located in the container, and in response to the previously determined distance being shorter than the currently determined distance, the controller is operable to compare the currently determined distance with a maximum distance, and:
open the valve to add material to the container if the currently determined distance is greater than a maximum distance, and
close the valve to not add material to the container if the currently determined distance is less than a minimum distance wherein the minimum distance is different than the maximum distance.

33. The system of claim 32 wherein the signal is a sound wave.

34. The system of claim 32 wherein the material includes at least one of the following: water, food, and medicine.

35. The system of claim 32 wherein the container includes a bucket sized and configured to allow a horse to retrieve material disposed inside the bucket.

36. The system of claim 32 wherein the controller is operable to calculate the volume of the material in the container from the distance of the surface of the material from the receiver.

37. The system of claim 32 further comprising the controller operable to ignore the received signal in response to the received signal having noise in an amount greater than the threshold amount of noise.

38. The system of claim 32 further comprising the controller, in response to the previously determined distance being longer than the currently determined distance, operable to compare the currently determined distance with the minimum distance and if the currently determined distance is greater than the minimum distance then the controller is operable to:
keep the valve open, if the valve is open,
keep the valve closed, if the valve is closed, and
save the currently determined distance for use as a distance from a signal previously reflected from the surface of the material located in the container, in a future comparison.

39. The system of claim 32 further comprising the controller operable to determine the location of an animal and in response to the location being near the container:
close the valve if the valve is open, and
determine the identity of the animal.

40. The system of claim 32 wherein the controller is operable to:
determine an amount of material consumed over a period, and
compare the amount of material consumed over the period with an historical average amount of material consumed over a similar period.

41. The system of claim 40 wherein the controller is operable to generate an alert in response to the amount of material consumed over the period being substantially different than the historical average amount consumed over the similar period.

42. The system of claim 32 further comprising a sensor operable to sense the identity of an animal while the animal removes material from the container.

43. The system of claim 32 further comprising a second receiver and a second transmitter operable to receive and transmit radio waves over a network.

44. The system of claim 32 further comprising a database coupled with the controller and operable to store data about the operation of the device.
